(19) United States
(12) Patent Application Publication
(10) Pub. No.: US 2011/0050421 A1
(43) Pub. Date: Mar. 3, 2011

(54) SYSTEMS, METHODS AND APPARATUS FOR DETERMINING DIRECTION OF MOTION OF A RADIO FREQUENCY IDENTIFICATION (RFID) TAG

(75) Inventors: Mark Duron, East Patchogue, NY (US); Benjamin Bekritsky, Modiin (IL); David Goren, Smithtown, NY (US); Miklos Stern, Woodmere, NY (US)

(73) Assignee: SYMBOL TECHNOLOGIES, INC., Holtsville, NY (US)

(21) Appl. No.: 12/549,459

(22) Filed: Aug. 28, 2009

(51) Int. Cl. G08B 13/14

(52) U.S. Cl. 340/572.1

(57) ABSTRACT

The present disclosure describes a system, methods and apparatus for determining a direction of motion of an RFID tag. An RFID reader is provided that includes an antenna that is tilted at a tilt angle with respect to a detection path. Response signals from the RFID tag are received at the antenna at different times, and an RSSI sample of each response signal is measured. Based on the RSSI samples, an RSSI/time data point is generated for each of the RSSI samples. Each RSSI/time data point defines a measured RSSI value for a particular RSSI sample versus a time that particular RSSI sample was measured. Based on the plurality of RSSI/time data points, the direction of motion of the RFID tag can be determined.

### TECHNICAL FIELD

Embodiments of the subject matter described herein relate generally to radio-frequency identification (RFID) technologies. More particularly, embodiments of the subject matter relate to RFID systems, methods, and apparatus for determining the direction of motion of an RFID tag.

### BACKGROUND

Radio frequency identification (RFID) systems have achieved wide popularity in a number of applications, as they provide a cost-effective way to track the location of a large number of items in real time. Most RFID systems include two primary components: an RFID reader (also known as an interrogator or RFID reader device); and one or more RFID tags (also known as RFID transponders). The RFID reader generates or emits a radio-frequency (RF) interrogation signal (sometimes also called a polling signal). The RFID tag is a miniature device that is capable of responding to the RF interrogation signal by generating an RF response signal that is transmitted back to the RFID reader over an RF channel. The RF response signal is modulated in a manner that conveys identification data (i.e., a tag identifier (ID)) for the responding RFID tag back to the RFID reader. In large-scale applications, such as warehouses, retail spaces, and the like, many types of RFID tags may exist in the environment (or “site”). Likewise, multiple types of readers, such as RFID readers, active tag readers, 802.11 tag readers, Zigbee tag readers, etc., are typically used throughout the space, and may be linked by network controller or wireless switches and the like.

RFID systems are used in a number of different applications such as object tracking, security, inventory control/tracking in retail stores, warehouses, shipping centers, etc. For instance, in one inventory tracking application, some retails stores have begun using the RFID technology to track the location of items/inventory/articles/merchandise present in the store. In such applications, each item has an RFID tag attached to it so that the item can be tracked as it moves about an inventory space.

RFID “portals” can be implemented at different points (e.g., an entrance/exit to the inventory space) to automatically track whether or not RFID tags (and hence the items they are attached to) have passed through the portal. In essence, an RFID portal is a RFID reader located at a known position such as a boundary between an entry/exit point. To determine whether or not a particular RFID tag has entered or exited the portal, knowing the direction of travel of an RFID tag is of interest.

FIG. 1 is a block diagram of an RFID tag 102 tracking system 100. The system 100 includes a fixed RFID reader 104 at a portal 103. The portal 103 is located at a boundary between an inventory space 110 and an external space 120. The RFID reader 104 is fixed at a known location or position. The particular known position can be determined by technologies and methods such as GPS location determination, dead-reckoning, manual input or any other technique, and specified using a Cartesian or other coordinate systems. This allows the location of the RFID reader 104 to be established with respect to the detection path 105. The RFID tag 102 can be moved in a first direction 130 of motion and a second direction 140 of motion along a detection path 105 between the inventory space 110 and the external space 120. The first direction 130 of motion is into the portal 103, out of the external space 120 and into the inventory space 110. The second direction 140 of motion is out of the portal 103, that is, out of the inventory space 110 and into the external space 120. The fixed RFID reader 104 is designed to read an RFID tag 102 as it passes through the portal 103. This is of importance, for example, in an inventory tracking system when the RFID tag 102 is coupled an item that is moving through the portal 103 since it may be desirable to determine whether the item is exiting or entering through the portal 103.

While it is desirable to know whether the RFID tag 102 has passed through the portal 103, it is more desirable to know in what direction the RFID tag 102 was moving as it passed through the portal 103 so that an inventory or monitoring system (not shown) can keep track of whether the item has exited or entered through the portal 103. This is particularly important in applications such as inventory control, etc., since it allows the relative location of an item (i.e., as being within an inventory space or as having left the inventory space) to be automatically tracked.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 illustrates a Radio Frequency Identification (RFID) tracking system;

FIG. 2 illustrates a block diagram of an RFID reader and a nearby RFID tag that can be used in accordance with some embodiments of the present disclosure;

FIG. 3 illustrates a RFID tracking system in accordance with some embodiments of the present disclosure;

FIG. 4 is a graph that illustrates expected RSSI curves of the RFID tag response signal at the RFID reader as a function of horizontal distance (dₕ) of the RFID tag from an origin point along the detection path when the antenna is tilted;

FIG. 5 is a flowchart illustrating a method for determining direction of motion of an RFID tag in accordance with some other embodiments of the present disclosure; and

FIG. 6 is a graph that illustrates measured RSSI of response signals transmitted from a first RFID tag at the RFID reader as a function of time when the antenna is tilted at a tilt angle of 60°.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, or the following detailed description.

Some embodiments of the present disclosure relate generally to determining direction of motion of an RFID tag. The many alternative embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of data transmission protocols and that the system described herein is merely one example embodiment of the invention.

For the sake of brevity, conventional techniques related to radio-frequency identification (RFID) data transmission, RFID system architectures, computing device architectures, and other functional aspects of the systems (and the individual operating components of the systems) may not be described in detail herein. Furthermore, the connecting lines shown in the various figures contained herein are intended to represent example functional relationships between the various elements. It should be noted that many alternative or additional functional relationships or physical connections may be present in a practical embodiment.

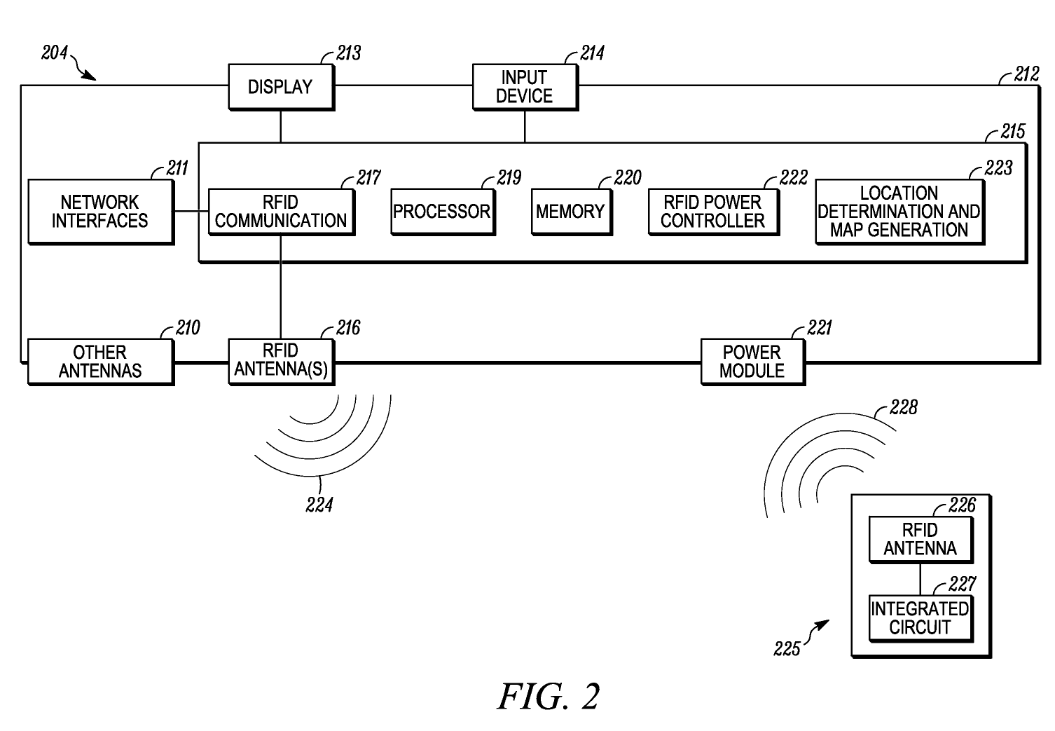

The following description may refer to elements or nodes or features being “connected” or “coupled” together. As used herein, unless expressly stated otherwise, “connected” means that one element/node/feature/device directly communicates with another element/node/feature/device. Likewise, unless expressly stated otherwise, “coupled” means that one element/node/feature/device directly or indirectly communicates with another element/node/feature/device. For example, although the schematic shown in FIG. 2, described below, depicts one example arrangement of an RFID reader, additional intervening elements, devices, features, or components may be present in an embodiment of the invention.

Overview

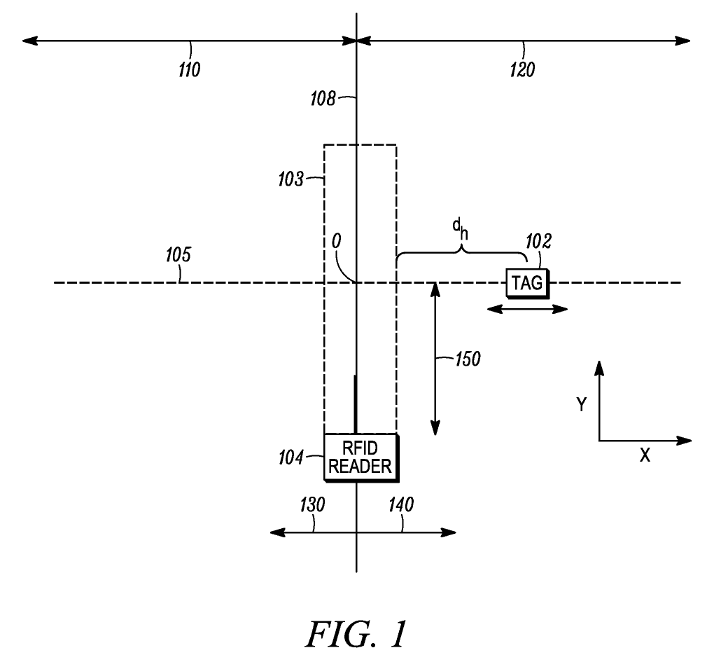

Referring again to FIG. 1, although techniques have been developed for determining what direction the RFID tag 102 was moving in as it passed through the portal 103, these techniques generally require the use of two RFID readers each having its own antenna, or an RFID reader with two spaced apart antennas at the portal 103. For example, according to one technique the sequence of read events from the two antennas is used to determine the direction of motion.

Accordingly, it is desirable to provide improved methods, systems and apparatus for determining which direction an RFID tag is moving in as it passes by an RFID reader. It is also desirable to provide improved RFID systems and methods for determining relative location(s) of item(s) with respect to an entry/exit point of an inventory space. It would also be desirable if such RFID systems are easy to deploy, maintain and operate. To reduce the cost of such RFID tracking systems and simplify installation of such RFID tracking systems, it would be desirable to provide improved techniques that can reduce the number of RFID readers required and/or reduce the complexity of the RFID reader by using a single reader with a single antenna.

According to one embodiment, a method is provided for determining direction of motion of an RFID tag. The method can be performed by an RFID reader located at a portal. In accordance with one exemplary embodiment of this method, direction of motion of an RFID tag can be determined as it moves along a detection path. The RFID reader includes an antenna (e.g., a directional antenna) that is tilted at a tilt angle with respect to the detection path. The tilt angle with respect to the detection path is the angle between the antenna and a direction parallel to the detection path, and is greater than 0 degrees and less than 180 degrees. The direction of motion that the RFID tag is moving in is determined with respect to the RFID reader along the detection path.

Response signals from the RFID tag are received at the antenna at different times, and an RSSI sample of each response signal is measured. Based on the RSSI samples, an RSSI/time data point is generated for each of the RSSI samples. Each RSSI/time data point defines a measured RSSI value for a particular RSSI sample versus a time that particular RSSI sample was measured. Based on the plurality of RSSI/time data points, the direction of motion of the RFID tag can be determined.

In accordance with one embodiment, the RSSI/time data point that has a maximum measured RSSI value is defined as a maximum RSSI/time data point, and the time at which the maximum RSSI/time data point was measured is defined as the maximum time point. Thereafter, a first group of the plurality of RSSI/time data points that were measured at times prior to when the maximum time point was measured are determined, and a second group of the plurality of RSSI/time data points that were measured at times occurring after the time when the maximum time point was measured are determined.

A first linear regression is then computed to generate a first line having a first slope. The first linear regression is computed based on the first group of the plurality of RSSI/time data points that were measured at times prior to when the maximum time point was measured. A second linear regression is also computed to generate a second line having a second slope. The second linear regression is computed based on the second group of the plurality of RSSI/time data points that were measured at times occurring after the time when the maximum time point was measured. It is then determined which one of the first slope and the second slope has a greater magnitude. When the second slope has the greater magnitude, it is determined that the RFID tag is moving in a first direction of motion (e.g., into the portal), and when the first slope has the greater magnitude, it is determined that the RFID tag is moving in a second direction of motion (e.g., out of the portal).

The disclosed embodiments allow for the direction of motion of an RFID tag to be determined via a RFID reader with a single antenna. This not only reduces cost and complexity of such systems, it simplifies customer installation since only a single reader having a single antenna can be used to determine the direction of motion of an RFID tag.

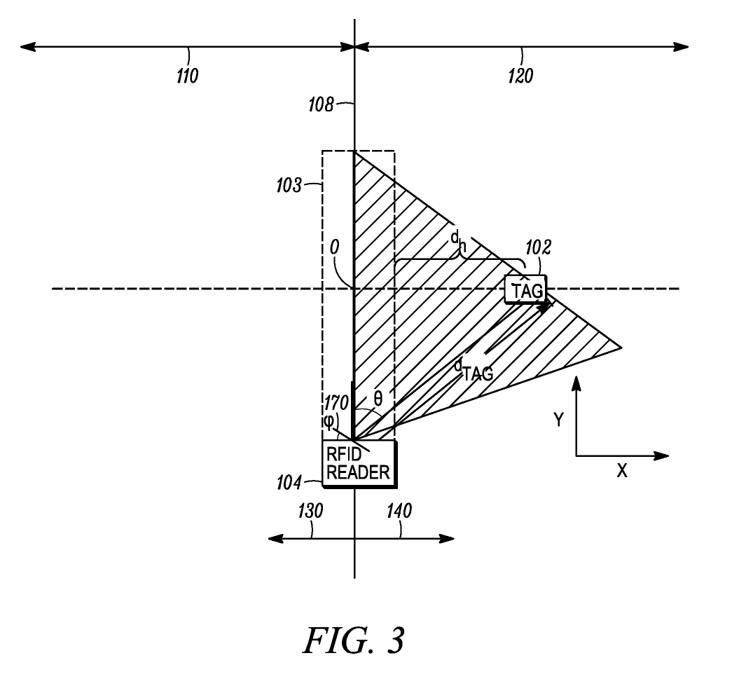

Other desirable features and characteristics of the present invention will become apparent from the subsequent detailed description and the appended claims, taken in conjunction with the accompanying drawings. Prior to describing some embodiments with reference to FIGS. 3-14, an example of an RFID reader and nearby RFID tag will then be described with reference to FIG. 2.

Exemplary RFID Reader

FIG. 2 illustrates a block diagram of an RFID reader 204 and nearby RFID tag 225 that can be used in accordance with some embodiments of the present disclosure. The RFID reader 204 can be implemented with an-off-the-shelf RFID reader 204, or other computer or computing device that runs one or more suitably configured software applications. In the following description of FIG. 2, the RFID reader 204 is configured to communicate with an exemplary RFID tag 225.

The functionality of the RFID reader 204 is explained with respect to various modules depicted in the block diagram. It is to be understood that the various modules are shown to facilitate better understanding of the RFID reader 204, and that the modules included in the RFID reader 204 are not meant to be a limitation on embodiments of the present disclosure. Depending on the implementation, the RFID reader 204 may be a fixed device or a handheld portable device. For instance, in embodiments described above with respect to FIG. 1D above, the RFID readers 104 are fixed, whereas in other embodiments (e.g., FIG. 7) the RFID reader is nomadic and can move about the space or environment 110. The following description of the RFID reader 204 has been explained with reference to components shown in FIG. 2. The RFID reader 204 is depicted in a simplified manner, and a practical embodiment can include many additional features and components.

Modules included in one implementation of the RFID reader 204 can generally include network interfaces 211 (that can include a wired network interface such as an Ethernet interface, and/or wireless interfaces, such as a WLAN interface), one or more other antennas 210, a housing 212, a display element 213 that is visible from the outside of the housing 212, input devices 214 that are accessible from the outside of the housing 212, an RFID electronics module 215 contained within the housing 212, an RFID antenna 216 (which can be, but is not necessarily, contained within the housing 212) and a power module 221 (e.g., a AC power source or a DC power source such as a rechargeable battery). The input devices 214 can include a keypad, a touch panel, a keyboard attached to a PC communicating with the RFID reader 204 or other input/output elements such as imaging devices (e.g. cameras including a digital camera, a video camera, etc.) that can be used to take a real time image (e.g., video image or picture) of an area covered by the imaging device of the RFID reader.

The display 213 and input device 214 function as input/output elements for the operator of the RFID reader 204. As will be described below, various software and hardware produce an image or graphical user interface (GUI) on the display 213 indicative of the position of the RIFD reader or readers, the RFID beacon tags 101, and RFID item tags 102 with respect to the RFID reader 104 or readers within environment 110. In various embodiments that will be described below, a coverage map (hereinafter also referred to as a map) can be displayed as a GUI on the display 213 (e.g., screen) of a RFID reader. The coverage map that is displayed on the display 213 of the RFID reader can display the entire space or environment 100 or any portion of the entire space or environment 100. In each of the embodiments described below, the coverage map can indicate read range information for one or more of the RFID readers that appear on the coverage map.

The display 213 and input device 214 can be coupled to the RFID electronics module 215 as necessary to support input/output functions in a conventional manner.

The RFID electronics module 215 represents the hardware components, logical components, and software functionality of the RFID reader 204. In practical embodiments, the RFID electronics module 215 can be physically realized as an integrated component, board, card, or package mounted within the housing 212. As depicted in FIG. 2, the electronics module 215 can be coupled to one or more RFID antennas 216, for example, via RF cables and RF connector assemblies. In one embodiment, multiple RFID antennas 216 are included. These RFID antennas 216 can include dual-polarized RFID antenna and circularly polarized RFID antenna. The RFID reader 204 can switch between the antennas to create different radiation patterns.

The RFID electronics module 215 may generally include a number of sub-modules, features, and components configured to support the functions described herein. For example, the electronics module 215 may include an RFID reader communication sub-module 217, at least one processor 219, memory 220, an RFID power controller sub-module 222 and a location determination and map generation sub-module 223. In a practical embodiment, the various sub-modules and functions need not be distinct physical or distinct functional elements. In other words, these (and other) functional modules of the RFID reader 204 may be realized as combined processing logic, a single application program, or the like.

The RFID electronics sub-module 215 also includes an RFID communication sub-module 217 designed to support RFID functions of the RFID reader 204 and to communicate with the RFID tags via RFID antenna(s) 216. The RFID communication module 217 can include an RFID reader transceiver that includes a transmitter and a receiver with conventional circuitry to enable digital or analog transmissions over a wireless communication channel. The transceiver enables the RFID reader 204 to communicate with the RFID beacon tags 101, 102 via antenna(s) 216.

For example, the RFID reader transceiver generates RFID interrogation signals and receives reflected RFID response signals generated by RFID tags in response to the interrogation signals. In the example embodiment described herein, the RFID communication sub-module 217 is designed to operate in the UHF frequency band designated for RFID systems. Alternate embodiments may instead utilize the High Frequency band or the Low Frequency band designated for RFID systems. The operation of RFID readers and RFID transceivers are generally known and, therefore, will not be described in detail herein. Notably, in this example embodiment, the RFID communication sub-module 217 is operable at various transmit power levels, as controlled by the RFID power controller 222 sub-module. The RFID power controller sub-module 222 can adjust the power of transmission of interrogation signals transmitted by the RFID antenna(s) 216. The transmit power level or radio signal strength of the interrogation signals can be adjusted so that the interrogation signals can travel varying distances from the RFID reader 204. For example, the operator of an RFID reader can adjust the transmit power level or radio signal strength to cover the area of interest, thus avoiding the interrogation or polling of items placed on other shelves or racks, which are of no interest in the current polling. In one non-limiting, exemplary embodiment, the RFID reader 204 provides a linear coverage for 10 feet of the space at a particular transmit power level, which translates into a circular coverage for 5 feet of the space at the particular transmit power level. The RFID power controller sub-module 222 can be embodied separately, or integrated with one or more other sub-modules.

The processor 219 can be any general purpose microprocessor, controller, or microcontroller that is suitably configured to control the operation of the RFID reader 204. In practice, the processor 219 executes one or more software applications that provide the desired functionality for the RFID reader 204, including the operating features described in more detail below. The memory 220 may be realized as any processor-readable medium, including an electronic circuit, a semiconductor memory device, a ROM, a flash memory, an erasable ROM, a floppy diskette, a CD-ROM, an optical disk, a hard disk, an organic memory element, or the like. As an example, the memory 220 is capable of storing RFID data captured by the RFID reader 204.

The power module 221 provides operating power to the RFID reader 204. In one embodiment, the power module 221 includes a battery that supplies power to the RFID reader 204. In some implementations, the battery is rechargeable via ambient lighting so that each RFID reader can be trickle charged. Power status of the RFID readers is communicated back to the central monitoring server 106 via the wireless link or a wired communication link, and low power conditions can set off alert signals for servicing. The power module 221 can also indirectly supply operating power to the RFID tags 225, if the RFID tags 225 are passive tags. Passive tags do not have a battery of their own, and therefore derive power from RF signals transmitted by the RFID readers. When a passive tag encounters radio waves from a reader, a coiled antenna within the RFID tag forms a field. The RFID tag draws power from it, energizing the circuits in the RFID tag.

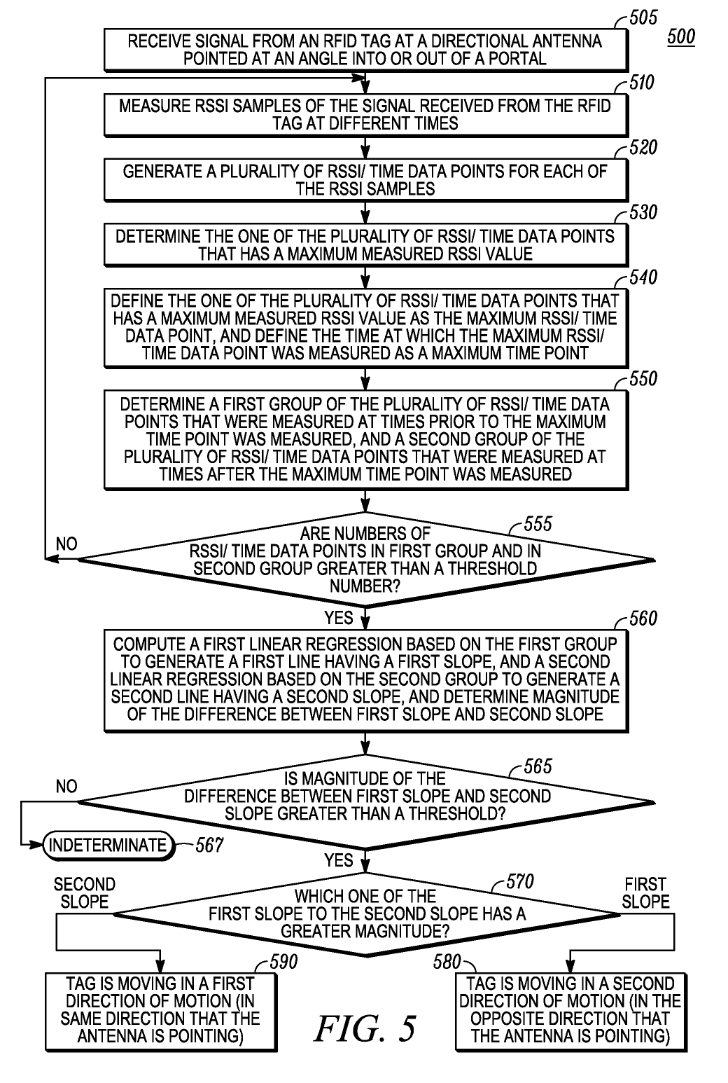

The tag motion directionality module 223 is a processor or equivalently a software module running on a processor that is designed to measure RSSI samples of the response signals received from the RFID tag 225 at different times. The value of the RSSI samples changes as the RFID tag 225 moves along the tag detection path 105 towards the RFID reader 204. The tag motion directionality module 223 generates a plurality of RSSI/time data points for each of the RSSI samples. Each RSSI/time data point defines a measured RSSI value for a particular RSSI sample versus a time that particular RSSI sample was measured. Based on plurality of RSSI/time data points, the tag motion directionality module 223 can then determine a direction of motion 130, 140 of the RFID tag 225 with respect to the RFID reader 204 as the RFID tag 225 passes the RFID reader 204 (e.g., as it moves through the portal 103). Depending on the direction 130, 140 that the RFID tag 225 is moving in, the RSSI values will have a different characteristic or signature. For instance, the RSSI values will slowly rise and abruptly disappear when moving in the first direction 130. The signal has the opposite sequence when traveling in the other second direction 140. As such, the tag motion directionality module 223 can determine whether the RFID tag 225 is moving in a first direction 130 of motion into the portal 103, or a second direction 140 of motion out of the portal 103. Different embodiments of processing performed by the tag motion directionality module 223 will be described below with reference to FIG. 5.

A RFID reader, such as the one described above, preferably is capable of functioning in one or more alternate modes, including the RFID reader mode. The primary functions of the RFID reader need not be limited to data capture and RFID tag interrogation. Rather, the RFID reader can be capable of multi-tasking and multi-functioning. Some functions, such as a bar-code scanner and alternate manual input interfaces, can also be present. In some embodiments, the RFID reader 204 can be a single device, while in others, multiple devices can combine various features to accomplish the functions listed above, and others desired for or necessary to the embodiment. A RFID reader, such as the one described above, is preferably used as in conjunction with the systems and methods described below.

The exemplary RFID tag 225 illustrated in FIG. 2 includes an integrated circuit 227, and includes an antenna 226. The RFID antenna 226 can receive RF signals such as an interrogation signal 224 and transmit RF signals, such as response signals 228. The integrated circuit 227 represents one or more modules cooperating to store and process information including demodulating RF interrogation signals and for modulating RF response signals, and other functions.

Examples of RFID tags include, but are not limited to, active tags, passive tags, semi-active tags, WiFi tags, 801.11 tags, and the like RFID tags. Note that the term “RFID” is not meant to limit the invention to any particular type of tag. That is, the term “tag” refers, in general, to any RF element that can be communicated with and has an ID (or “ID signal”) that can be read by another component. In general, RFID tags may be classified as either an active tag, a passive tag, a semi-active tag or a semi-passive tag. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. A semi-passive tag is a tag with a battery source that is used to extend the range beyond that of a passive tag, but still user passive backscatter to communicate with the reader. While active tags are more powerful, and exhibit a greater range than passive tags, they also have a shorter lifetime and are more expensive. Such tags are well known in the art, and need not be described in detail herein. For example, one implementation of the RFID item tags is disclosed, for example, in U.S. patent application Ser. No. 12/185867, attorney docket number SBL08079, entitled “Method of Configuring RFID Reader” filed Aug. 5, 2008 and assigned to the assignee of the present invention, its contents being incorporated by reference in its entirety herein.

Each antenna 226 within RFID reader 204 has an associated RF read range (or “coverage area”), which depends upon, among other things, the gain of the respective antenna or strength of the transmit signal of the respective antenna. The read range corresponds to the coverage area around the antenna 216 in which a tag 225 may be read by that antenna, and may be defined by a variety of shapes, depending upon the nature of the antenna.

The exemplary RFID tag 225 can be positioned within transmission range or read range of the RFID reader 204. When the RFID tag 225 receives the interrogation signal 224 with its RFID antenna 226, the integrated circuit 227 can perform one or more operations in response, including demodulating the interrogation signal 224 (to know when and with what to respond) and modulating the interrogation signal 224 using “backscatter modulation” (e.g., modulating the reflection coefficient of its antenna with the information to respond with), and transmitting the modulated interrogation signal 224 from the RFID antenna 226 as a response signal 228.

The RFID reader 204 can receive the response signal 228, and extract useful information from it including, but is not limited to, the identity of the RFID tag 225 (i.e., a tag identifier).

Although not illustrated in FIG. 2, the RFID reader can communicate information with an access point or port, a wireless switch, and a monitoring server, such as that described, for example, in U.S. patent application Ser. No. 12/369,838, filed Feb. 12, 2009, entitled “Displaying Radio Frequency Identification (RFID) Read Range Of An RFID Reader Based On Feedback From Fixed RFID Beacon Tags,” and assigned to the assignee of the present invention, which is incorporated herein by reference in its entirety.

Various embodiments of the present disclosure will now be described with respect to FIGS. 3-14.

RFID Tracking System

FIG. 3 illustrates a Radio Frequency Identification (RFID) tracking system 300 in accordance with some embodiments of the present disclosure. The system 300 is similar to that illustrated in FIG. 1. As in FIG. 1, the system 300 includes an RFID tag 102. However, in the disclosed embodiments, a single, fixed RFID reader 104 is used at the portal 103 to determine the relative direction of motion of the RFID tag 102. This RFID reader 104 is “fixed” at known location/position/coordinate, and utilizes only a single antenna to determine direction in which an RFID tag 102 is moving.

The RFID tag 102 is not at fixed locations/positions/coordinates and can be moved around and taken into or out of the space 110. The RFID tag 102 can move within the inventory space 110 and the external space 120. Although the RFID tag 102 can move along the detection path 105, it is also true that it can move anywhere within the inventory space 110 and the external space 120. Moreover, it can move, then stop, move again, etc. In other words, its movement pattern is not necessarily linear (along the detection path 105) and is not necessarily continuous. However, in some cases, the RFID tag 102 can move on a path that can be in a first direction 130 of motion and a second direction 140 of motion along a detection path 105 at any particular time. In this example, like that in FIG. 1, the first direction 130 of motion is into the portal 103, and the second direction 140 of motion is out of the portal 103. The detection path 105 extends along between an inventory space 110 and a second space 120, which in some implementations can be external to the inventory space 110, and in other implementations can be a different portion of section of the inventory space 110. As used herein, the inventory space 110 is a controlled space where items having RFID tags can be stored at least temporarily. The space 110 can be located within a building or other site (alternatively referred to as an “environment”). Note that while a single two-dimensional space 110 is illustrated in FIG. 3, the invention is not so limited. That is, space 110 may be any two-dimensional or three-dimensional space within or without a building and other structure. Example environments include, for example, single-story buildings, multi-story buildings, school campuses, commercial buildings, retail spaces, warehouses, and the like structures.

The fixed RFID reader 104 can be placed or located at an entry/exit point boundary 108 between the first space 110 and the second space 120 to define a portal 103 located a first distance 150 from the detection path 105. The entry/exit point boundary 108 is aligned with a center plane of the RFID reader 104. In one implementation, the portal 103 can be defined, for example, an entrance to a building or other structure. The fixed RFID reader 104 can interrogate the RFID tag 102 when it is within the read range of the reader 104. In response, the tag 102 transmits response signals, which include relevant tag data including identification information for each RFID tag. The identification data for each RFID tag 102 is stored at the RFID reader 104 (and at a monitoring server) so that the RFID reader 104 knows which RFID tag 102 transmitted the response signal. When the RFID tag 102 is attached to an item, the RFID tag 102 can include information pertaining to details regarding that item (e.g., item type, price, size, quality, and the like).

As the RFID tag 102 moves along towards the RFID reader 104, it can follow the detection path 105. The detection path 105 extends in the x-direction, and hence the direction perpendicular to the detection path 105 can be defined as the y-direction. The angle θ is the angle between the RFID tag 102 and the direction perpendicular to the detection path 105 at any point in time as the RFID tag 102 moves along the detection path 105. A tag distance (d_{tag}) is defined as the distance between the tag 102 and the RFID reader 104 at any particular time as the RFID tag 102 moves along the detection path 105.

The RFID reader 104 transmits RF interrogation signals on a regular basis, and when the RFID tag 102 is within the read range of the RFID reader 104, it will receive the interrogations signals. In response, the RFID tag 102 transmits RF response signals that can be received by the RFID reader 104.

Upon receiving the RF response signals, the RFID reader 104 can measure a receive signal strength (RSS) of each response signal received from the RFID tag 102. In particular, in accordance with the disclosed embodiments, when the RFID reader 104 receives the response signals, it can measure an RSSI value associated with each response signal and record it along with a time stamp which indicates when it was received.

In general, the closer the RFID tag 102 is to the RFID reader 104, the greater the RSS measurement will be and vice-versa. As the RFID tag 102 moves along the detection path 105, in many cases it will eventually pass through the portal 103 at the entry/exit point boundary 108 and hence past the RFID reader 104. The receive signal strength of the response signal from the RFID tag 102 will be at a maximum at the entry/exit point boundary 108.

The RFID reader 104 includes a transmitter, a receiver, a processor and a RFID antenna 170. The antenna 170 can be directional RFID antenna 170 (sometimes also referred to as a beam antenna) is an antenna which radiates greater power in one or more directions allowing for a greater concentration of radiation in a certain direction, increased performance on transmit and receive, and reduced interference from unwanted sources. In accordance with the disclosed embodiments, the directional RFID antenna 170 is tilted at a “tilt angle.” The tilt angle (φ) is the angle between the detection path 105 (x-axis) and the antenna 170 of the RFID reader 104. In other words, the antenna 170 is tilted at an angle (φ) with respect to the direction parallel to the detection path 105 (which is defined as the y-direction above). As used herein, the term “tilt angle” refers an orientation of the antenna 170 of the RFID reader 104 at an angle (φ) greater than 0° with respect to the detection path 105 (x-axis) but not perpendicular to the detection path 105 (x-axis). The antenna 170 of the RFID reader 104 is tilted an angle with respect to the detection path so that the antenna 170 points at an angle that is either into the portal or out of the portal. As will be described below, a single directional antenna that is tilted in one direction with respect to the detection path 105 provides enough asymmetry so that the reader 104 can determine whether the RFID tag 102 is moving in a direction that is into or out of the portal 103. As such, the direction of motion of the RFID tag 102 can be determined using only one RFID reader 104 that has only a single antenna.

The received signal strength indicator (RSSI) of a response signal received at the RFID reader 104, which is equal to the received signal power (P_{reader}) at the RFID reader 104 in dBm, can be expressed as shown in equation (1) as follows:

$$RSSI = {P}_{reader} = {P}_{tag} - 5 + 20 log ( \frac{c}{4 π} ) - 20 log f - 20 log {d}_{tag} + 20 log {cos}^{2} ( θ - ϕ ) \qquad ( Equation 1 )$$

where c is the speed of light, f is the transmit frequency of the interrogation signal, d_{tag} is the tag distance, θ is the angle between the RFID tag 102 and the direction perpendicular to the detection path 105, and φ is the tilt angle of the antenna.

The power received by the RFID tag 102 (P_{tag}) can be expressed as shown in equation (2) as follows:

$${P}_{tag} = 30 + 20 log ( \frac{c}{4 π} ) - 20 log f - 20 log {d}_{tag} + 20 log {cos}^{2} ( θ - ϕ ) \qquad ( Equation 2 )$$

When the RFID reader's antenna 170 is tilted at a tilt angle (φ), the RSSI measured at the RFID reader 104 will vary in a predictable manner that depends on a horizontal distance (dₕ) that the RFID tag 102 is located at from an origin point along the detection path 105. This origin point is defined at the location where the entry/exit point boundary 108 (center plane of the RFID reader 104) intersects the detection path 105. The first distance 150 between the RFID reader 104 and the origin point (O) of the detection path 105 is known. The origin point (O) is the point along the detection path 105 that crosses the plane of the portal.

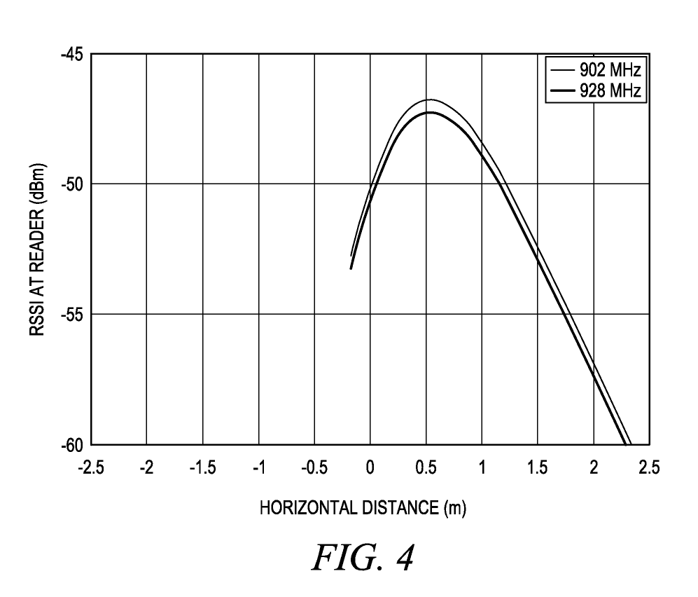

FIG. 4 is a graph that illustrates expected RSSI curves of the RFID tag response signal at the RFID reader as a function of horizontal distance (dₕ) of the RFID tag from an origin point along the detection path 105 when the antenna 170 is tilted. The expected RSSI curves are computed in dBm based on equations (1) and (2) above. The horizontal distance (dₕ) in meters. In this example, the tilt angle (φ) of the antenna 170 is 30°. FIG. 4 illustrates the expected RSSI versus distance curves at two different frequencies 902 MHz and 928 MHz.

FIG. 4 illustrates that the slopes around the maximum RSSI will be effected when the antenna 170 is tilted at an angle with respect to the detection path. In other words, when the antenna 170 is tilted and the RFID tag 102 is moves from left to right in FIG. 3, the expected RSSI should first have a sharp upward slope, then hit a maximum, and finally have a shallow downward slope. By contrast, when the antenna is tilted and the RFID tag 102 is moving from right to left in FIG. 3, then the expected RSSI should first have a shallow upward slope, then hit a maximum, and finally have a sharp downward slope. This will be explained in greater detail below with actual experimental results.

Referring again to FIG. 3, upon receiving response signals from the RFID tag 102, the processor of the RFID reader 104 is designed to measure RSSI samples of the response signals received from the RFID tag 102 at different times. The value of the RSSI samples changes as the RFID tag 102 moves along the tag detection path 105 towards the RFID reader 104. The RFID reader 104 generates a plurality of RSSI/time data points for each of the RSSI samples. Each RSSI/time data point defines a measured RSSI value for a particular RSSI sample versus a time that particular RSSI sample was measured.

Based on plurality of RSSI/time data points, the RFID reader can then determine a direction of motion 130, 140 of the RFID tag 102 with respect to the RFID reader 104 as the RFID tag 102 passes the RFID reader 104 (e.g., as it moves through the portal 103). Depending on the direction 130, 140 that the RFID tag 102 is moving in, the RSSI values will have a different characteristic or signature. For instance, the RSSI values will slowly rise and abruptly disappear when moving in the first direction 130. The signal has the opposite sequence when traveling in the other second direction 140. As such, the RFID reader 104 can determine whether the RFID tag 102 is moving in a first direction 130 of motion into the portal 103, or a second direction 140 of motion out of the portal 103. Different embodiments of processing performed by the processor will be described below with reference to FIG. 5.

FIG. 5 is a flowchart illustrating a method 500 for determining direction of motion of an RFID tag in accordance with some other embodiments of the present disclosure. In one implementation, the method 500 can be performed by a processor at the RFID reader 104. In other implementations, the method 500 can be performed a network computer that is communicatively coupled to the RFID reader 104, such as a monitoring server (not illustrated in FIG. 3, but incorporated by reference above). It is noted that steps 555 and 565 are optional and need not be performed in all implementations of the method 500.

The method 500 begins at step 505 when the RFID reader 104 receives a response signal from the RFID tag 102, at which point the RFID reader 104 creates a record for that RFID tag 102. The antenna 170 of the RFID reader 104 is tilted an angle with respect to the detection path so that the antenna 170 points at an angle that is either into the portal or out of the portal. At step 510, the processor begins tracking RSSIs from the RFID tag 102 with respect to time, and measures RSSI samples of the response signals received from the RFID tag 102 at different times.

At step 520, the processor generates a plurality of RSSI/time data points for each of the RSSI samples. Each RSSI/time data point defines a measured RSSI value for a particular RSSI sample versus a time that particular RSSI sample was measured. In general, at least some of the RSSI samples correspond to response signals transmitted by the RFID tag 102 as the RFID tag 102 moves along the detection path 105 towards the RFID reader 104.

Steps 530 through 590 describe further processing performed by the processor to determine a direction of motion of the RFID tag 102 with respect to the RFID reader 104 based on the plurality of RSSI/time data points.

As described above, the RFID tag 102 can be moving in the first direction 130 of motion into the portal 103 or in the second direction 140 of motion out of the portal 103. Either way, when the RFID tag 102 is approaching the RFID reader 104, a series of RSSI values will be measured. As the RFID tag 102 moves through the portal 103 and passes the RFID reader 104, the RSSI sample taken when the RFID tag 102 is closest to the RFID reader 104 will have a maximum value. As the RFID tag 102 moves away from the RFID reader 104, the maximum value will be followed by a series of RSSI samples having lower values.

At step 530, the processor determines the one of the plurality of RSSI/time data points that has a maximum measured RSSI value. At step 540, the processor defines the one of the plurality of RSSI/time data points that has the maximum measured RSSI value as the maximum RSSI/time data point, and defines the time at which the maximum RSSI/time data point was measured as a maximum time point (i.e., the time at which the RSSI/time data point having the maximum measured RSSI value was measured). At step 550, the processor determines a first group of the plurality of RSSI/time data points that were measured at times prior to when the maximum time point was measured, and determines a second group of the plurality of RSSI/time data points that were measured at times occurring after the time when the maximum time point was measured.

Step 555 is optional. If it is not performed, then the method 500 can proceed to step 560 following step 550. In implementations in which optional step 555 is performed, the processor determines whether a first number of RSSI/time data points in the first group of the plurality of RSSI/time data points is greater than a threshold number, and whether a second number of RSSI/time data points in the second group of the plurality of RSSI/time data points is greater than the threshold number. This check can be performed to ensure that an adequate number of data points are being used to make any subsequent decisions. The threshold numbers used for each comparison can be the same or different depending on the specific implementation.

If either the first number or the second number is less than the threshold number, then the method 500 loops back to step 510 so that additional RSSI samples of the signal received from the RFID tag 102 can be measured at different times, and additional RSSI/time data points for each of the RSSI samples can be recorded to improve the overall data set being used in subsequent determinations. If both the first number of RSSI/time data points in the first group and the second number of RSSI/time data points in the second group are greater than (or equal to) the threshold number, then the method 500 proceeds to step 560.

At step 560, the processor computes a first linear regression based on the first group to generate a first line having a first slope (i.e., a linear regression in the data before the maximum), and computes a second linear regression based on the second group to generate a second line having a second slope (i.e., a linear regression in the date after the maximum). In accordance with the disclosed embodiments, any known linear regression technique can be utilized to compute the first linear regression (of the first group of the plurality of RSSI/time data points that were measured at times prior to when the maximum time point was measured) and the second linear regression (of the second group of the plurality of RSSI/time data points that were measured at times occurring after the time when the maximum time point was measured).

As will be understood by those skilled in the art, a linear regression refers to any approach to modeling the relationship between one or more variables denoted y and one or more variables denoted X, such that the model depends linearly on the unknown parameters to be estimated from the data. In many cases, linear regression refers to a model in which the conditional mean of y given the value of X is an affine function of X. Less commonly, linear regression can refer to a model in which the median, or some other quantile of the conditional distribution of y given X is expressed as a linear function of X. Like all forms of regression analysis, linear regression focuses on the conditional probability distribution of y given X, rather than on the joint probability distribution of y and X, which is the domain of multivariate analysis. Linear regression models are often fit using the least squares approach, but may also be fit in other ways, such as by minimizing the “lack of fit” in some other norm, or by minimizing a penalized version of the least squares loss function as in ridge regression.

Step 565 is optional. If it is not performed, then the method 500 can proceed to step 570 following step 560. In implementations in which optional step 565 is performed, the processor determines whether a magnitude of a difference between the first slope and the second slope is greater than or equal to a difference threshold.

If the magnitude of the difference between the first slope and the second slope is less than the difference threshold, then the method 500 would be deemed indeterminate at 567. Other methods (not described herein) may be used to determine the direction of travel in this case.

If the magnitude of the difference between the first slope and the second slope is greater than or equal to the difference threshold, then the method 500 proceeds to step 570, where the processor determines which of the first slope to the second slope has a greater magnitude. When the first slope has the greater magnitude, the method proceeds to step 580, where the processor determines that RFID tag 102 is moving in the second direction 140 of motion that is the opposite direction that the antenna 170 is pointing in (i.e., in this case out of the portal 103 from left to right in FIG. 3). When the second slope has the greater magnitude, the method 500 proceeds to step 590, where the processor determines that the RFID tag 102 is moving in the first direction of motion is moving in the first direction 130 of motion that is the same direction that the antenna 170 is pointing in (i.e., in this case into the portal 103 from right to left in FIG. 3). Once the direction of motion is determined at step 580, 590, the result can be stored (e.g., at a monitoring server) with a time indication that indicates when the direction of motion was determined, and/or displayed to a user to show them in what direction that tag/item is moving. The monitoring server can use this information to perform inventory control and/or tracking using any techniques known in the art. For instance, when the RFID tag can not be immediately located, the user can determine if it has left a controlled area and went into an external space, or it is still within the inventory space and needs to be searched for further.

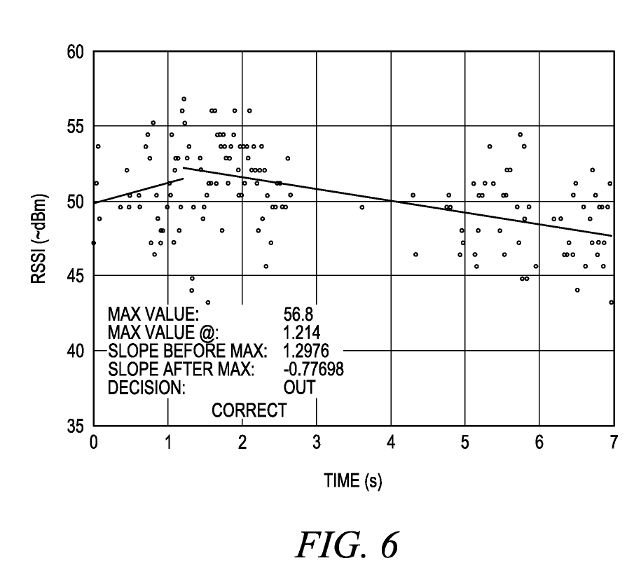

FIG. 6 is a graph that illustrates measured power of response signals transmitted from a first RFID tag at the RFID reader 104 in dB as a function of time (in seconds) when the antenna 170 is tilted at a tilt angle of 60°. FIG. 6 was experimentally determined using a “first RFID tag” that was moving in the second direction 140 of motion or out of the portal 103 (i.e., from left to right in FIG. 3). Each small circle on the graph represents a measured power sample of a response signal received from the RFID tag 102 at a particular time, or “power/time data point” that defines a measured power value for a particular sample versus a time that particular sample was measured. The actual RSSI values are offset from the measured power values. In this particular example, occurs at a “maximum time point” of 1.214 seconds. Each line on the graph represents a linear regression of data points before or after the maximum time point. In particular, the first line represents a first linear regression in the data before the maximum time point that is computed based on a first group of the data points that were measured at times prior to when the maximum time point was measured. Likewise, the second line represents a second linear regression in the data after the maximum time point that is computed based on a second group of the data points that were measured at times occurring after the time when the maximum time point was measured. In this example, the magnitude of the slope of the first line (1.2976) is greater than the magnitude of the slope (0.77698) of the second line. When the first slope has the greater magnitude, the processor determines that RFID tag 102 is moving in the second direction 140 of motion or out of the portal 103 (i.e., from left to right in FIG. 3). As such, in this example, the correct decision was made regarding the direction of motion of the RFID tag 102.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for determining a direction of motion of a Radio Frequency Identification (RFID) tag when moving along a detection path, the method comprising:
receiving, at an antenna tilted at a tilt angle with respect to the detection path, response signals at different times from the RFID tag;
measuring a plurality of RSSI samples of the response signals received from the RFID tag;
generating a plurality of RSSI/time data points for each of the RSSI samples, wherein each RSSI/time data point defines a measured RSSI value for a particular RSSI sample versus a time that particular RSSI sample was measured;
determining the direction of motion of the RFID tag based on the plurality of RSSI/time data points.

2. A method according to claim 1, wherein the step of determining the direction of motion of the RFID tag based on the plurality of RSSI/time data points, comprises:
determining the one of the plurality of RSSI/time data points that has a maximum measured RSSI value;
defining the one of the plurality of RSSI/time data points that has the maximum measured RSSI value as a maximum RSSI/time data point, and defining a time at which the maximum RSSI/time data point was measured as a maximum time point;
determining a first group of the plurality of RSSI/time data points that were measured at times prior to when the maximum time point was measured, and a second group of the plurality of RSSI/time data points that were measured at times occurring after the time when the maximum time point was measured;
computing a first linear regression based on the first group of the plurality of RSSI/time data points that were measured at times prior to when the maximum time point was measured to generate a first line having a first slope, and a second linear regression based on the second group of the plurality of RSSI/time data points that were measured at times occurring after the time when the maximum time point was measured to generate a second line having a second slope;
determining which of the first slope to the second slope has a greater magnitude;
determining that RFID tag is moving in a first direction of motion when the second slope has the greater magnitude; and
determining that RFID tag is moving in a second direction of motion when the first slope has the greater magnitude.

3. A method according to claim 2, wherein the method is performed by an RFID reader located at a portal.

4. A method according to claim 3, wherein the first direction of motion is into the portal and wherein the second direction of motion is out of the portal.

5. A method according to claim 3, wherein the direction of motion that the RFID tag is moving is with respect to the RFID reader along the detection path.

6. A method according to claim 1, wherein the antenna is a directional antenna.

7. A method according to claim 1, wherein the tilt angle with respect to the detection path is the angle between the antenna and a direction parallel to the detection path.

8. A method according to claim 7, wherein the tilt angle with respect to the detection path is greater than 0 degrees and less than 180 degrees.

9. A Radio Frequency Identification (RFID) reader designed to determine a direction of motion of an RFID tag when moving along a detection path, the RFID reader comprising:
an antenna tilted at a tilt angle with respect to the detection path, and being designed to receive response signals at different times from the RFID tag;
a processor designed to: measure a plurality of RSSI samples of the response signals received from the RFID tag, generate a plurality of RSSI/time data points for each of the RSSI samples, wherein each RSSI/time data point defines a measured RSSI value for a particular RSSI sample versus a time that particular RSSI sample was measured, and determine the direction of motion of the RFID tag based on the plurality of RSSI/time data points.

10. A RFID reader according to claim 9, wherein the processor is further designed to:
determine the one of the plurality of RSSI/time data points that has a maximum measured RSSI value, define the one of the plurality of RSSI/time data points that has the maximum measured RSSI value as a maximum RSSI/time data point, and define a time at which the maximum RSSI/time data point was measured as a maximum time point;
determine a first group of the plurality of RSSI/time data points that were measured at times prior to when the maximum time point was measured, and a second group of the plurality of RSSI/time data points that were measured at times occurring after the time when the maximum time point was measured;
compute a first linear regression based on the first group of the plurality of RSSI/time data points that were measured at times prior to when the maximum time point was measured to generate a first line having a first slope, and a second linear regression based on the second group of the plurality of RSSI/time data points that were measured at times occurring after the time when the maximum time point was measured to generate a second line having a second slope; and
determine which of the first slope to the second slope has a greater magnitude, and to determine that RFID tag is moving in a first direction of motion when the second slope has the greater magnitude, and that RFID tag is moving in a second direction of motion when the first slope has the greater magnitude.

11. A RFID reader according to claim 10, wherein the RFID reader is located at a portal.

12. A RFID reader according to claim 11, wherein the first direction of motion is into the portal and wherein the second direction of motion is out of the portal, wherein the antenna points into the portal or out of the portal.

13. A RFID reader according to claim 11, wherein the direction of motion that the RFID tag is moving is with respect to the RFID reader along the detection path.

14. A RFID reader according to claim 9, wherein the antenna is a directional antenna.

15. A RFID reader according to claim 9, wherein the tilt angle with respect to the detection path is the angle between the antenna and a direction parallel to the detection path.

16. A RFID reader according to claim 15, wherein the tilt angle with respect to the detection path is greater than 0 degrees and less than 180 degrees.

17. A system, comprising:
a Radio Frequency Identification (RFID) tag;
a detection path; and
a portal comprising an RFID reader designed to determine a direction of motion of the RFID tag when moving with respect to the RFID reader along the detection path, the RFID reader comprising:
an antenna tilted at a tilt angle with respect to the detection path so that it points into the portal or out of the portal, and being designed to receive response signals from the RFID tag at different times;
a transmitter designed to transmit interrogation signals from the antenna;
a receiver designed to receive response signals from the RFID tag via the antenna; and
a processor designed to: measure a plurality of RSSI samples of the response signals received from the RFID tag, generate a plurality of RSSI/time data points for each of the RSSI samples, wherein each RSSI/time data point defines a measured RSSI value for a particular RSSI sample versus a time that particular RSSI sample was measured, and determine the direction of motion of the RFID tag based on the plurality of RSSI/time data points.

18. A system according to claim 17, wherein the processor is further designed to:
determine the one of the plurality of RSSI/time data points that has a maximum measured RSSI value, define the one of the plurality of RSSI/time data points that has the maximum measured RSSI value as a maximum RSSI/time data point, and define a time at which the maximum RSSI/time data point was measured as a maximum time point;
determine a first group of the plurality of RSSI/time data points that were measured at times prior to when the maximum time point was measured, and a second group of the plurality of RSSI/time data points that were measured at times occurring after the time when the maximum time point was measured;
compute a first linear regression based on the first group of the plurality of RSSI/time data points that were measured at times prior to when the maximum time point was measured to generate a first line having a first slope, and a second linear regression based on the second group of the plurality of RSSI/time data points that were measured at times occurring after the time when the maximum time point was measured to generate a second line having a second slope; and
determine which of the first slope to the second slope has a greater magnitude, and to determine that RFID tag is moving in a first direction of motion into the portal when the second slope has the greater magnitude, and that RFID tag is moving in a second direction of motion out of the portal when the first slope has the greater magnitude.

19. A system according to claim 19, wherein the antenna is a directional antenna.

20. A system according to claim 19, wherein the tilt angle with respect to the detection path is the angle between the antenna and a direction parallel to the detection path, and wherein the tilt angle with respect to the detection path is greater than 0 degrees and less than 180 degrees.
